(19) United States
(12) Patent Application Publication
(10) Pub. No.: US 2009/0099920 A1
(43) Pub. Date: Apr. 16, 2009

(54) Data Mining

(76) Inventors: Asaf Aharoni, Herzelia (IL); Ishai Oren, Herzelia (IL); Elon Portugaly, Herzelia (IL); Ido Priness, Herzelia (IL)

Correspondence Address: MICROSOFT CORPORATION, ONE MICROSOFT WAY, REDMOND, WA, 98052, US

(21) Appl. No.: 12/208,113

(22) Filed: Sep. 10, 2008

Related U.S. Application Data
(60) Provisional application No. 60/971,506, filed on Sep. 11, 2007.

(51) Int. Cl. G06Q 30/00; G06F 7/00

(52) U.S. Cl. 705/14; 707/7; 707/E17.002

(57) ABSTRACT

Data mining techniques are described. In an implementation, one or more computer-readable media include instructions that are executable on a device to output a user interface describing a list of segments ranked according to a ranking function, the segments demonstrating distinct behavior in one or more attributes over a plurality of clients described in client data and the ranking function containing settings that are enterable via the user interface to specify a business agenda.

### CROSS REFERENCE TO RELATED APPLICATIONS

This application claims priority under 35 U.S.C. Section 119 to provisional patent application No. 60/971,506 which is titled “Segment discovery and ranking engines”, filed Sep. 11, 2007, the entire disclosure of which is hereby incorporated by reference in its entirety.

### BACKGROUND

The business value of data that describes clients (e.g., who they are and/or what they do) can be enormous to an advertiser, and extensive resources are dedicated to creating and maintaining the data. However, the very abundance of data presents an “embarrassment of riches”, as there are so many starting points and possible avenues of investigation.

Traditional data mining techniques may involve numerous and various domain experts in the data mining loop: marketing professionals, data mining analysts, statisticians, database and IT personnel. Accordingly, these traditional techniques are time consuming, human intensive and typically non-scalable. As a result, this process is traditionally decided upon at a high level, and suffers from bottlenecks that are unrelated to the marketing capacity of the organization, e.g., the number of active concurrent campaigns, level of targeting, and so on. Additionally, the number of people involved often results in a lack of clarity as to the data mining goal on one hand and the meaning of the results on the other. As a result, utilization of the business information encapsulated in the data may be suboptimal using traditional data mining techniques.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Data mining techniques are described. In an implementation, a change is made to an observed distribution of data, inducing a respective change to a calculated expected model. The changed observed distribution and respective changed expected model are compared via a scoring function. The changes that bring the expected model closest to the observed are iteratively adopted, until significant changes do not remain or the overall change to the observed distribution reaches a limit.

In an implementation, one or more computer readable media have instructions executable to reduce redundancies in data by constructing a graph having vertices that represent the parameters and edges that represent similarity above a threshold. A vertex cover of non-redundant parameters is selected such that each parameter that is to be discarded is redundant with at least one remaining parameter.

In an implementation, one or more computer readable media include a reference distribution module that is executable on one or more devices to accept as an input categorized values of an attribute over each case of an input data to be mined and a segment definition rule. The reference distribution module is also executable on one or more devices to output a reference distribution over categories of the categorization of an attribute. A behavioral attribute scoring module is executable on one or more devices to accept as an input a distribution of cases of a segment over the categories of a candidate behavior attribute and the reference distribution and output a score indicating how interesting the segment is over the candidate behavioral parameter.

In an implementation, one or more segments are extracted from a multivariate distribution, each of the segments typifying intra-dependencies of a set of input variables. A list is output in a user interface referencing each of the one or more segments and a respective score indicating how interesting the segment is over one or more behavioral parameters.

In an implementation, client data is obtained that describes interaction of a plurality of clients with an online provider. Segments, rule-based or otherwise, are found that demonstrate distinct behavior in one or more attributes of the plurality of clients described in the client data. Henceforth, a segment is a subset of the plurality of clients, a rule-based segment being defined as all ones of the plurality of clients satisfying constraints on one or more attributes. A ranking function is applied to the segments, the ranking function containing pre-coded settings that specify a business agenda. A list is then output having segments ranked according to the application of the ranking function.

In an implementation one or more computer-readable media include instructions that are executable to extract a list of segments that describes intra-dependencies of a set of input variables from a multivariate distribution.

In an implementation, a system includes one or more modules to output a user interface to target advertisements to particular ones of a plurality of clients that interact with an online provider, the particular clients identified in the user interface using rule-based or other segments ranked according to a ranking function. The segments demonstrate distinct behavior in one or more attributes of the plurality of clients described in client data.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ data mining techniques.

FIG. 2 is an illustration of a system in an example implementation in which the redundancy module of FIG. 1 is shown in greater detail.

FIG. 3 is a flow diagram depicting a procedure in an example implementation in which a technique for redundancy reduction is described.

FIG. 4 is an illustration of a graph with two minimal vertex covers.

FIG. 5 depicts a system in an example implementation showing an outlier module of FIG. 1 in greater detail.

FIG. 6 is a flow diagram depicting a procedure in an example implementation in which a technique for outlier removal is described.

FIG. 7 depicts an example system which illustrates the outlier module 122 of FIGS. 1 and 5 in greater detail.

FIG. 8 depicts a system in an example implementation showing an extraction module of FIG. 1 in greater detail.

FIG. 9 is a flow diagram depicting a procedure in an example implementation in which segments are extracted from a plurality of multivariate distributions.

FIG. 10 is a flow diagram depicting a procedure in an example implementation in which a list of segments is calculated to be output by a representative segments selection module.

FIG. 11 is a flow diagram depicting a procedure in an example implementation in which segment discovery and ranking that may involve user input is shown.

FIG. 12 depicts an example implementation of a system showing a behavior module of FIG. 1 in greater detail.

FIG. 13 depicts an example implementation in which a list of behavior attributes is output that show interesting behavior.

FIG. 14 is a flow diagram depicting a procedure in an example implementation in which segment discovery and ranking that may involve user input is shown, and re-ranking tolerance is determined post-factum.

### DETAILED DESCRIPTION

In the following discussion, an example environment is first described that may employ data mining techniques described herein. Example techniques are then described, which may be employed in the example environment, as well as in other environments. Accordingly, implementation of the data mining techniques is not limited to the example environment, and vice versa.

Example Environment

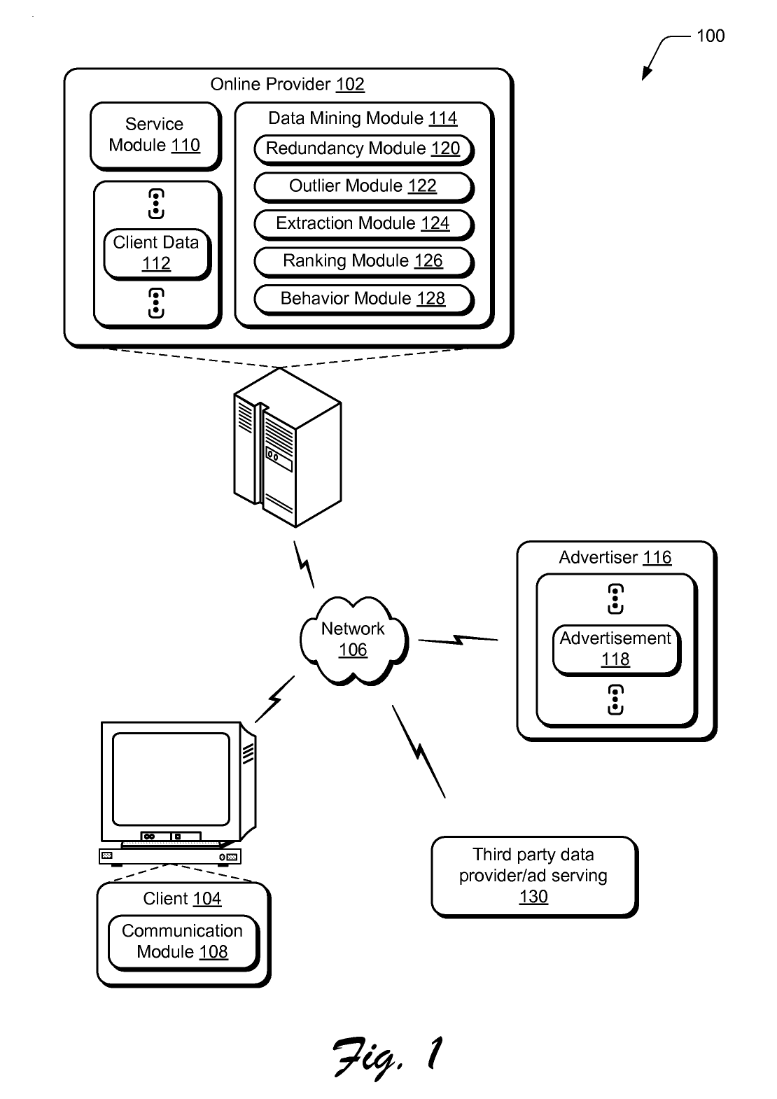

FIG. 1 is an illustration of an environment 100 in an example implementation that is operable to employ data mining techniques. The illustrated environment 100 includes an online provider 102 and a client 104 that are communicatively coupled, one to another, via a network 106. The clients 104 may be configured in a variety of ways. For example, the client 104 may be configured as a computer that is capable of communicating over the network 106, such as a desktop computer, a mobile station, an entertainment appliance, a set-top box communicatively coupled to a display device, a wireless phone, a game console, and so forth. Thus, the client 104 may range from a full resource device with substantial memory and processor resources (e.g., personal computers, game consoles) to a low-resource device with limited memory and/or processing resources (e.g., traditional set-top boxes, hand-held game consoles). The client 104 may also relate to a person and/or entity that operates the clients. In other words, client 104 may describe logical clients that include users, software and/or devices. Further, the client 104 may be representative of a plurality of clients. Accordingly, the client 104 may be referred to in singular form (e.g., the client 104) or plural form (e.g., the clients 104, the plurality of clients 104 and so on) in the following discussion.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The client 104 is further illustrated as including a communication module 108, which is representative of functionality of the client 104 to communicate over the network 106. For example, the communication module 108 may be representative of browser functionality to navigate over the World Wide Web, may also be representative of hardware used to obtain a network connection (e.g., wireless), and so on.

For example, the client 104 may execute the communication module 108 to communicate with the online provider 102 via the network 106. Henceforth, online provider shall refer to any operator or agent thereof who provides one or more of the following services: search, browsing, content, internet access, mail, software as a service, ad serving, newsletters, or any other online service whose pattern of use may be mined to characterize individual clients. The online provider 102 is illustrated as including a service module 110, which is representative of functionality of the online provider 102 to locate content (e.g., web pages, images, and so on) of interest to the client 104. For example, the service module 110 may operate as a search engine that indexes web pages for searching.

The online provider 102 is also illustrated as including client data 112, which is representative of data that describes the client 104 and/or online activity performed by the client 104 and/or data on client 104 provided by a third party 130. For example, the client data 112 may include a unique identifier to differentiate the clients 104, one from another. The client data 112 may also describe characteristics of the client, such as demographic data pertaining to a user of the client 104, functionality of the client 104 (e.g., particular hardware and/or software), and so on. The client data 112 may also describe actions performed by the client 104, such as searches, content or other services requested by the client 104 from the online provider 102. Thus, the client data 112 may describe a wide variety of data that pertains to the client 104. Although client data 112 is shown, a variety of other types of data may also be utilized with the techniques described herein, as further described in greater detail below.

The online provider 102 is also illustrated as including a data mining module 114 that is representative of functionality to perform data mining. Data mining may be performed by the data mining module 114 for a variety of purposes, such as to provide a service to an advertiser 116 to target particular advertisements 118 to particular clients 104. Although the data mining module 114 is illustrated as a part of the online provider 102, the data mining module 114 may be implemented in a variety of ways, such as through a stand-alone service, with another service (e.g., the advertiser 116), a client side application running partly or wholly on the client 104, and so on.

The data mining module 114 is further illustrated as including a plurality of different sub-modules that represent different functionalities that may be employed by the data mining module 114 in one or more implementations. For example, the redundancy module 120 is representative of functionality that addresses redundant parameters in the client data 112, further discussion of which may be found in relation to the “Redundancy Reduction” section below. The outlier module 122 is representative of functionality of the data mining module 114 that addresses “outliers” in the client data 112, further discussion of which may be found in the “Outlier Removal” section below. The extraction module 124 is representative of functionality of the data mining module 114 to extract segments from a multivariate distribution sample, further discussion of which may be found in relation to the “Segment Extraction” section below. The ranking module 126 is representative of functionality of the data mining module 114 to rank the segments extracted by the extraction module 124 or other segments defined by other means or externally provided, further discussion of which may be found in relation to the “Segment Ranking” section below. The behavior module 128 is representative of functionality of the data mining module 114 to analyze segments using behavioral profiling, further discussion of which may be found in relation to the “Behavioral Profiling” section below. Although these sub-modules are illustrated separately for clarity in the discussion, it should be readily apparent that the modules may be combined, used in isolation from each other, further divided, and so on.

Although the environment 100 described in relation to FIG. 1 pertains to Internet activity and advertising, it should be readily apparent that the environment 100 may assume a wide variety of different configurations. For example, today's enterprise-scale businesses often collect vast amounts of data relating to their customers, actual and potential. This data may be collected by various units inside the business itself, acquired from third parties, and so on. This data may serve a variety of business objectives, such as billing, cross-selling and up-selling, customer relationship management, campaign management, churn prediction, new customer acquisition, targeted marketing, and so on.

In the telecom industry, for example, up to thirty percent of subscribers churn each year. Accordingly, churn reduction is a strategic business goal for telecom companies. The cost of retaining a customer is considerably lower than that of acquiring a new customer, as long as the potential churner is identified early enough. Consequently, a behavioral characterization of the potential churner by the data mining module 114 is useful for several reasons. Subscribers might have different reasons for churning, and therefore identification of the reasons may significantly increase the chances of retention. Also, subscribers might respond to different retention incentives, and therefore it may be important to match the subscribers with the offer that is most attractive to them, with an offer that is cheapest to retain them, and so on. Furthermore, the techniques used to communicate with the subscriber (e.g., phone conversation, text message, email, regular mail, and so on) may be matched to the behavioral profile, such as an SMS text to texters, phone conversation to voice-only users, and so on. A segment-based approach with behavioral characterization would thus be advantageous to an abstract scoring model, which may be used to predict a likelihood of churn.

In another example, a chain retailer may seek to leverage data on existing customers to locate and target new customers for the retailer's products. The process may include three stages: identifying existing customer segments; locating concentrations of potential customers similar to those in the identified segments; and targeting the potential customers with the appropriate campaign. Again, having an abstract model for a potential customer's likelihood to purchase may be insufficient as it is also important that the marketer understand who the customer is, what the customer wants, how to approach the customer, how to capitalize on the full value of the business intelligence in the data, and so on.

Returning to the original example, advertising has taken an increasingly significant share of the bottom line in the online business environment. In fact, even though online advertising is in its early stages, online advertising is projected to assume the lion's share of the total advertising business.

In a typical online advertising scenario, users are presented ads in the context of a current search or the content of the page the users are currently viewing. Accordingly, different users in the same context will be presented the same advertisements, further differentiation possible only according to a few non-behavioral parameters such as location, time of day, and so on. Consequently, the data mining module 114 may provide techniques that are advantageous to each of the parties involved to refine advertisement targeting according to user-specific parameters. For example, contextual targeting may be augmented or replaced with user targeting. For the publisher, this means increasing and optimizing inventory yield. For the advertiser, this may result in a higher return on investment. Additionally, the users may be provided with advertisements having increased suitability to the users.

The client data 112 collected for online advertisement may be an aggregation from several data sources: demographic data provided by the user through a registration process or third parties; browsing history in first or third party sites; search query history; newsletter subscription, blogs, social and communication networks; and so on. Accordingly, this client data 112 may cover hundreds of millions of clients 104 across multiple features, whether log-based or aggregated. Therefore, the overall number of features across all clients 104 may reach several million.

The business value of this data can be enormous, and extensive resources are dedicated to creating and maintaining the data. However, the very abundance of data presents an “embarrassment of riches”, as there are so many starting points and possible avenues of investigation. Furthermore, traditional techniques involve numerous and various domain experts in the data mining loop: marketing professionals, data mining analysts, statisticians, database and IT personnel. This process is time consuming, human intensive and typically non-scalable. As a result, this process is traditionally decided upon at a high level, and suffers from bottlenecks that are unrelated to the marketing capacity of the organization, e.g., the number of active concurrent campaigns, level of targeting, and so on. Additionally, the number of people involved often results in lack of clarity as to the data mining goal on one hand and the meaning of the results on the other. As a result, utilization of the business information encapsulated in the data may be suboptimal. Moreover, the dynamic nature of the various markets represented in online marketing, and the constantly evolving nature of the data itself, typically involves quick turnaround of advertiser-specific “custom” segments, a process not supported in traditional techniques for the reasons outlined above. The above also applies to segmenting objects other than human users (with appropriate feature changes having been carried out), such as ads, websites, consumer products etc. Data mining techniques described herein may provide a comprehensive end-to-end solution to the problems described above, thereby allowing a user (e.g., marketing professional) to discover and evaluate business-prioritized segments directly from the data, in a timely, automated manner. The techniques may be implemented by systems that take on a variety of tasks both before and after the core data mining algorithms, which are not handled in traditional systems and consequently involve additional personnel and effort. The original data (e.g., client data 112) may be transformed into a space of simple, easy to understand (e.g. rule-based) segments, which are ranked by a mathematical model of business interest over and above statistical significance. The ranking function contains pre-coded settings that are modifiable by the user to better approximate the actual business agenda, both before the segmentation engine is run and adaptively, in light of segments already found. Ranking the segments allows discovery, management and navigation through significantly more segments than currently possible, in particular overcoming the requirement that segments be disjoint.

A desirable side effect of this is the ability to cover the population or a significant part thereof with simpler, easier to understand segments, greatly increasing their business applicability and value. The traditional reluctance of marketers to adopt “black box” segments is overcome by a simple behavioral characterization of each segment allowing the user to drill down into segment particulars.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices. The features of the data mining techniques described below are platform-independent, meaning that the techniques may be implemented on a variety of commercial computing platforms having a variety of processors. In an implementation, the online provider 102, the client 104 and the advertiser 116 are representative of one or more respective devices that include a processor and memory configured to maintain instructions that are executable on the processor.

Redundancy Reduction

In data mining scenarios, similar or even identical attributes are often repeated under different names. This may occur due to different schemes of categorizing or storing attribute values, to repetition across different data bases merged together, or simply a high level of correlation that introduces unwanted redundancy.

This duplication degrades both performance (e.g., time, memory and/or cost) and the quality of the results (e.g., accuracy and/or succinctness). Consequently, a data analyst using traditional data mining techniques may expend a significant amount of effort removing duplicated or otherwise redundant parameters during the pre-processing stage, syncing data fixes across repetitions, and so on. Traditionally, analyzing, comprehending and distilling the results of a data mining application is often the most time-consuming stage, which may be further complicated by sifting through superfluous data.

Traditional techniques that were used to reduce the amount of superfluous data were inefficient and difficult to use. For example, dimension reduction methods often result in artificial parameters that are difficult to interpret, which may make the results less actionable from a business point of view. Principal Component Analysis (PCA), for instance, computes new variables as linear combinations of original parameters. Parameter clustering keeps the parameters intact, but often groups together seemingly disparate parameters, and stops short of actually reducing redundancies in each parameter cluster. Furthermore, these traditional techniques are often limited to numerical representations of the parameters that exhibit “nice” behavior such as “close to normal” or “dense” distributions.

Techniques are described to compute a similarity measure between parameters, which may then be used to reduce redundancies. In one or more implementation, the similarity measure may be oblivious of data type and may take into account high-order interactions. In an implementation, a graph is constructed having vertices that represent parameters and edges that represent similarity above a user-specified threshold. A vertex cover of non-redundant parameters is then chosen such that each discarded parameter is redundant with at least one remaining parameter. In an implementation, these techniques may be implemented automatically. In another implementation, these techniques may be implemented to include a user interface to enable interaction with a data analyst regarding which parameters are to be kept or discarded.

Parameter Similarity Matrix Creation

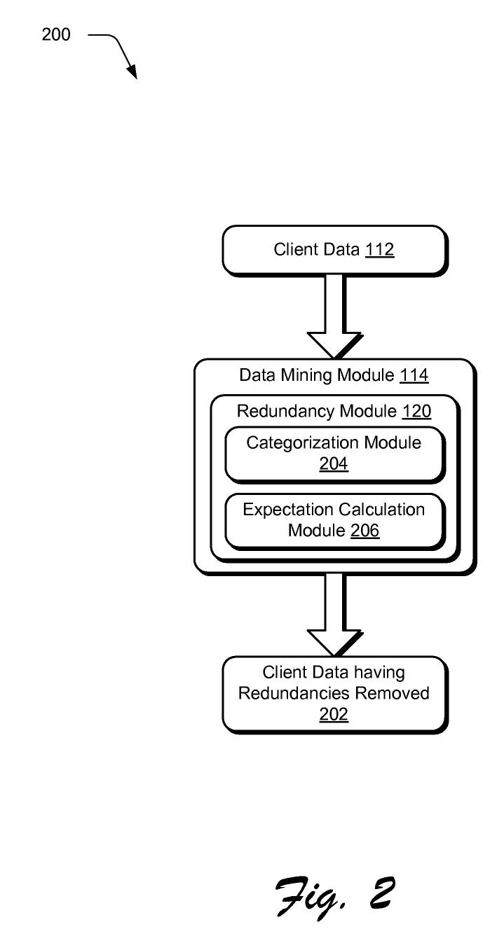

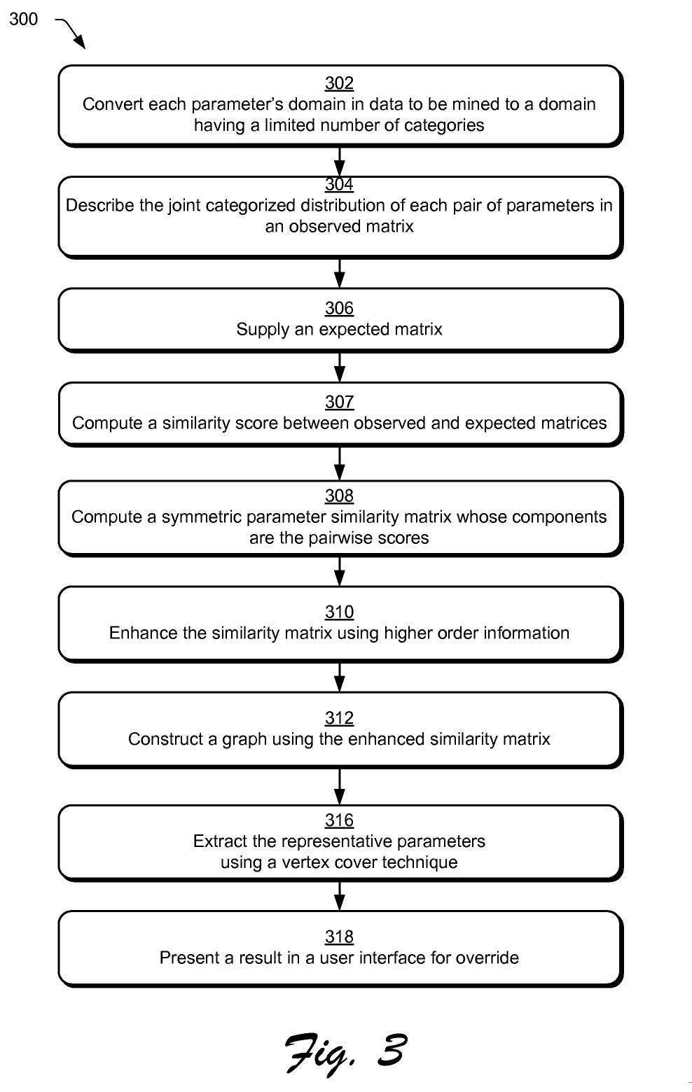

FIG. 2 illustrates a system 200 in an example implementation in which the redundancy module 120 of FIG. 1 is shown in greater detail. In the following discussion, reference will also be made to an example procedure 300 of FIG. 3. Aspects of this procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

The data mining module 114 is illustrated as processing client data 112 into a form such that the client data has redundancies removed 202. To do this, the redundancy module 120 is illustrated as including a categorization module 204 and an expectation calculation module 206.

For example, given a panel of N parameters times T cases, the redundancy module 120 computes an N×N symmetric similarity matrix, S_{N×N}={sᵢⱼ}_{i,j=1}^{N}, where sᵢⱼ represents the similarity between parameter i and parameter j. In an implementation, the similarity function is able to handle parameters with non-numeric value range, with possibly different value ranges. This is achieved by first categorizing those variables that are not already categorized, computing a contingency table for each of the categorized parameter pairs, namely matrix A_{m×n} below, and computing the parameter similarity from the contingency tables. In an implementation, the categorization module 204 is first applied to each parameter separately. The categorization module 204 converts each parameter's domain to a domain having a limited number of categories (block 302). The categorization module 204 may employ one or more of the following functionalities: Automatic equi-probability or near equi-probability binning with adjustment for discrete indivisible values; automatic identification of atomic values which capture a sizeable fraction of the distribution, and allocation of separate bins for such values; automatic identification of special values (such as 0), which should not be internal to the value range of any bin; interface for human intervention to override, adjust and label bin value range categories; automatic ordering of non-ordered values according to correlation with other input parameters or a calculated score, so that value range binning is made possible; and automatic binning of non-ordinal values by means of any of a variety of clustering methods with respect to correlation with other input variables or a calculated score.

Following the use of the categorization module 204, the distribution of each pair of parameters may be described using an m×n matrix A_{m×n}={a_{k,l}}_{k,l=1}^{m,n}, where m, n are the number of categories in parameters i,j correspondingly and a_{k,l} is the number of cases with category k in parameter i and category l in parameter j (block 304). Then, the expectation module 206 supplies a corresponding expected matrix, B_{m×n}={b_{k,l}}_{k,l=1}^{m,n} (block 306).

Given the two matrices, a similarity score may be calculated (block 307), an example of which is shown using Cramer's phi function below:

$${ϕ}_{c} = \sqrt{\frac{{\sum }_{k , l = 1}^{m , n} \frac{{( {a}_{k , l} - {b}_{k , l} )}^{2}}{{b}_{k , l}}}{N * min ( m - 1 , n - 1 )}}$$

This function returns a number between 0 and 1, where 0 means complete independence and 1 implies a deterministic relationship. A symmetric parameter similarity matrix may be computed, whose component at index (i,j) is the computed similarity between attributes i and j (block 308).

Similarity Matrix Enhancement

Parameter similarity computed via contingency tables (although being robust to extreme distribution and to sparse parameters due to the categorization process) may still suffer from inaccuracies due to a lack of information. Accordingly, the similarity matrix may be enhanced (block 310). The enhancement process gathers and uses indirect information about the relations between parameters in order to enhance the similarity matrix. For instance, instead of directly using the similarity score between parameter i and parameter j, the similarity score between parameter i and parameter k may be used, together with the score between parameter j and parameter k. Averaging on each possible k has a moderating effect on the score. It should be readily apparent that additional information may be used, such as longer paths between i and j. The longer the path, the more information is available. However, the information may be more indirect.

In the following example, paths of length 3 are used since longer paths tend to introduce more indirect knowledge about the relation between the parameters as described above. The formula for the enhanced matrix is simply

$${S}^{′} = \frac{{SS}^{t}}{N} = \frac{S \times S}{N} ,$$

or a Pearson correlation matrix where rows of S are first normalized to a 0 mean and unit variance before computing S′=SS^{t}.

Similarity Graph Creation

The enhanced similarity matrix may then be used in order to construct a graph (block 312), which reflects the similarity between the different parameters. Because the matrix is symmetric, the graph that is constructed is undirected. The graph can be weighted and thus supply a graphical representation of the matrix (i.e., the edge weight between vertex i and vertex j would be S′_{i,j}), or edges could correspond to similarity values above a threshold or set of thresholds. For example, a-priori distinguished parameters might involve a higher threshold to be considered redundant, or thresholds could be determined according to vertex degree in the graph.

Alternatively, edges may correspond to user-specified levels that match parameters with identical data, have the same underlying data with different coding, and/or have the same underlying data with different categorization. A variety of different examples are contemplated. For example, an external single threshold may be provided by a user. Consequently, an edge is included in a corresponding graph between vertex i and vertex j if and only if S′_{i,j}>t, where t is the abovementioned threshold.

Extraction of Representative Parameters

Extraction of the representative parameters is performed, such as by using the similarity graph to extract a subset of the parameters (block 316) that satisfy the following criteria: each of the original parameters has a strong correlation with at least one of the output parameters; all else being equal, the parameter with higher entropy is chosen; and a parameter cannot be discarded without violating the first condition, as shown in the following example.

For example, an improvement to the greedy algorithm may be used to find a small vertex cover for the graph. Given an undirected graph G where {1, . . . , N} is the set of vertices and E is the set of edges (the unordered pair (i,j)∈E iff the edge between i and j appears in the graph), a minimal vertex cover is a set V⊂{1, . . . , N} such that ∀iε{1, . . . , N}∃j∈V:(i,j)∈E, and such that no proper subset of V possesses this property. Note that there may be more than one minimal vertex cover, not necessarily of the same size.

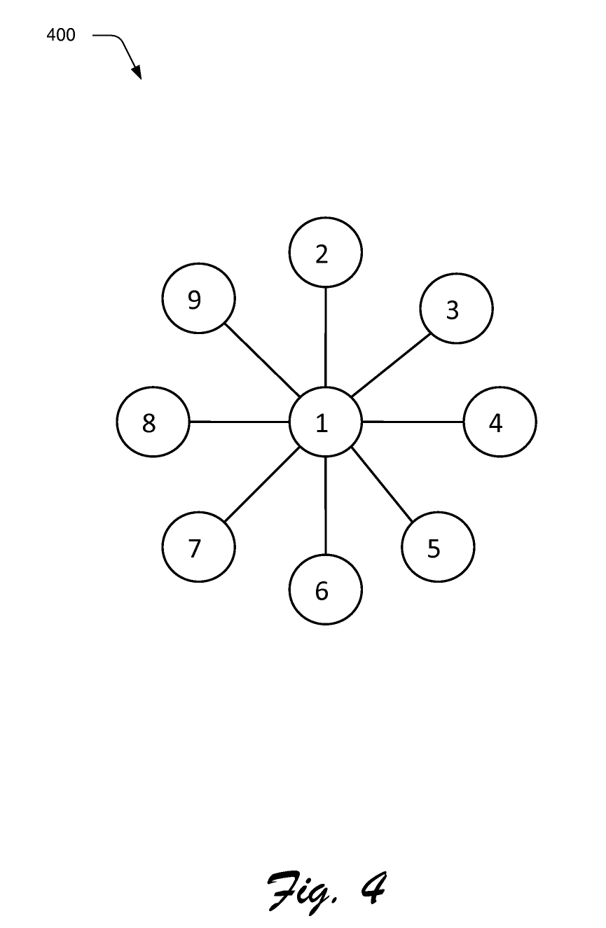

The graph 400 illustrated in FIG. 4 has two minimal vertex covers: the set {1}; and the set {2, 3, 4, 5, 6, 7, 8, 9}. The smallest size vertex cover is then found, which is minimal. Since this problem is NP-complete in the general case, a greedy algorithm may be used as follows:
(1) Start with the empty set c={ };
(2) Take the vertex i with the following property: The set (N(i)∪{i})∩({1, . . . , N}−(C∪N(C)) is maximal in size; and N(C) is the set of all neighbors of C. In other words, by adding i to C the set of vertices covered by C (including C itself) is increased by the most when compared to other vertices. In case of a tie, the vertex is chosen that corresponds to the parameter with highest entropy.
(3) Add i to C, if N(C)∪C={1, . . . , N} go to 4, else go to 2.
(4) Determine if there are any vertices that can be removed from C without impairing the domination property. If there are, remove that with smallest entropy and repeat the process until C is minimal.
   The output of the algorithm is a minimal vertex cover. Heuristically it is of small size, and in many situations is close to optimal.

UI and Control for Selection Override

The vertex cover problem for a graph decomposes into independent problems for each connected component. The results of the automatic techniques described above may be presented to the user as grouped by connected components, not including singletons for which a redundancy is not detected. At the component level, the user may override the selection process for a variety of reasons (block 318). For example, a certain version of some parameter may be more up to date, or more familiar in the organization; a more coarsely grained categorization may be more useful, albeit less informational; the threshold suitable for one class of parameters may not be suitable for others; statistically redundant parameters may serve different purposes (English version vs. French); and so on.

For example, a user may select a set S of parameters and the redundancy module 120 may complete S to a vertex cover by first removing S∪N(S) from the graph, computing a minimal vertex cover C for the remaining sub-graph and outputting S∪C. A variety of other examples are also contemplated.

Outlier Removal

Data mining may be used to process a set of data samples across multiple attributes. However, traditional data mining techniques are often sensitive to a relatively small amount of damaged or extreme values. These “outliers” may have little if any contribution to a data mining goal, and in fact often overshadow meaningful phenomena. Consequently, it traditionally took expert “outside knowledge” to pick out the meaningful phenomena from seemingly more significant statistical deviations.

A salient characteristic of outliers is the ability to cause various scores computed on the data to become highly discontinuous. Accordingly, the outlier removal techniques described herein may be used to remove outliers by using this disruption to automatically detect and remove the outliers.

In the context of hundreds and thousands of statistical tests run on the data, an automatic system for outlier removal may facilitate the work of a user, e.g., a data analyst. Accordingly, the data analyst may concentrate and leverage relevant skills on true business goals, rather than being lost in the “noise” caused by the outliers.

For example, suppose a certain population is described in the client data 112, such as by specifying zip code and number of registered cars for each individual. Now suppose a few records in the sample were corrupted, so that each of the corrupted fields are set to 99999. Accordingly, the matrix of multivariate distribution might look like this:

| #cars\zip code | 90210 | 98052 | 99999 |
|---|---|---|---|
| 0 | 5238 | 8434 | 0 |
| 1 | 7301 | 10917 | 0 |
| 2 | 6239 | 5928 | 0 |
| 3-5 | 4192 | 2619 | 0 |
| 6+ | 198 | 51 | 7 |

The entry “7” in the bottom right hand corner is statistically the most significant with respect to a null hypothesis of independence. However, a competent data analyst would rule it out due to “external knowledge”, specifically that “99999” is likely an erroneous zip code. Once the outliers are extracted, the data analyst may then reach a meaningful conclusion that residents in the Beverly Hills zip code own more cars per capita. Furthermore, hundreds of similar matrices may make it difficult for the expert to observe meaningful phenomena from the data when such corruption is present. Accordingly, the outlier techniques described herein may enable a business manager with little to no data mining experience to directly access meaningful business-relevant results.

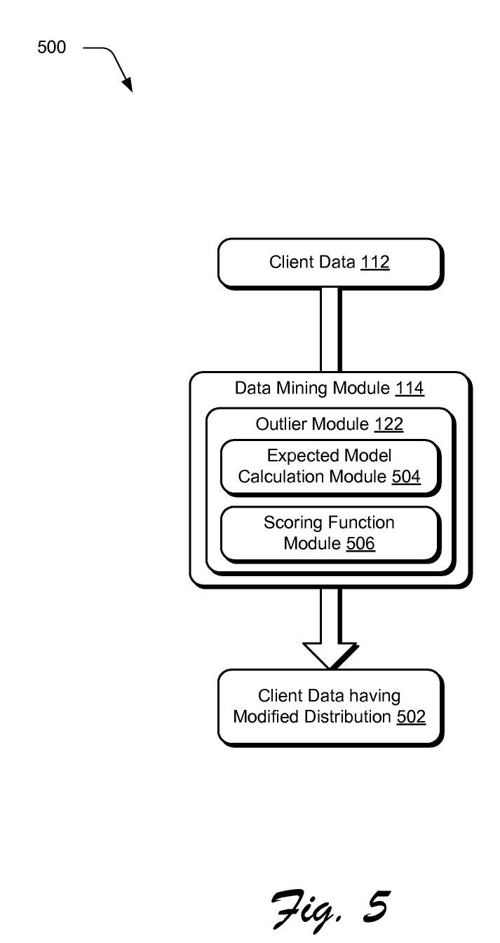

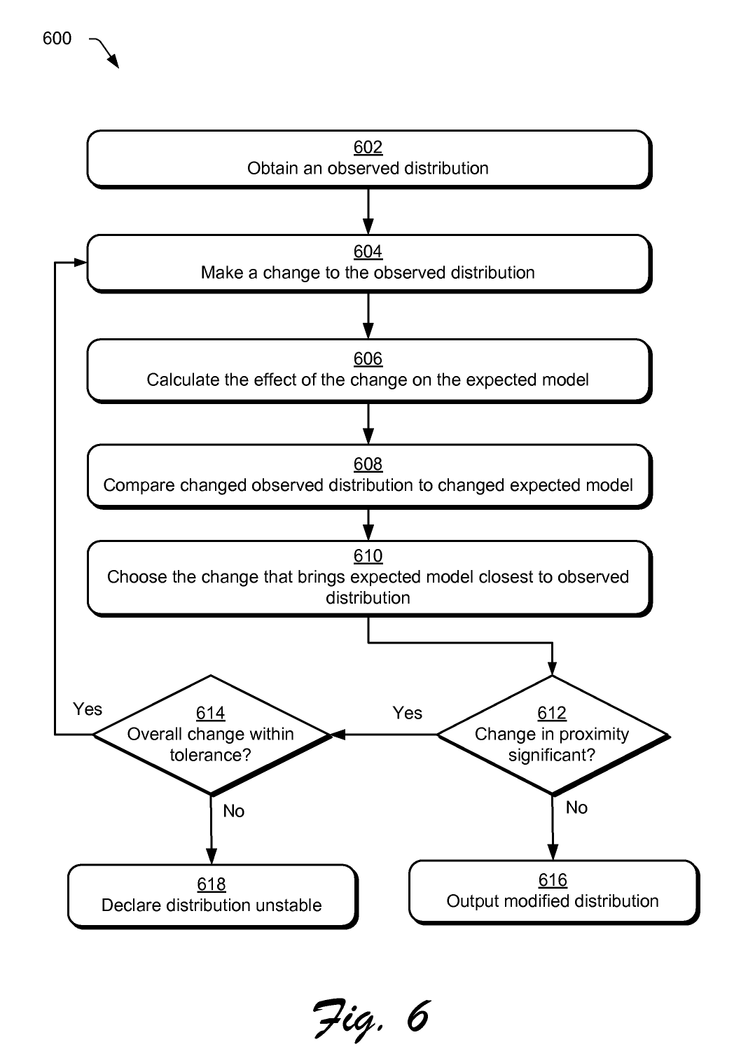

FIG. 5 depicts a system 500 in an example implementation showing the outlier module 122 of FIG. 1 in greater detail. In the following discussion, reference will also be made to an example procedure 600 of FIG. 6. Aspects of this procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made to the environment 100 of FIG. 1 and the system 500 of FIG. 5.

In an implementation, the outlier module 122 receives a single- or multivariate distribution and/or computes such a distribution from raw data, an example of which is illustrated as client data 112 in FIG. 5 (block 602). A process is applied to the input that moderately changes the distribution, such as a “smoothing process”. The output is the modified distribution 502.

The outlier module 122 is illustrated as including an expected model calculation module 504 and a scoring function module 506. The expected model calculation module 504 is representative of functionality to extract an expected distribution out of a given (e.g., observed) distribution (block 604), such as a multivariate distribution. For instance, the expected model calculation module 504 may use an independence model or an observed distribution in some reference population as a basis for the calculation.

The scoring function module 506 is representative of functionality to provide a distribution comparing function, called a “score”. The calculation is performed via some metric or combination of metrics. The score reflects the deviation of the computed expected distribution from the original distribution. It may or may not resemble a function that was used to rank phenomena externally to the smoothing algorithm.

The outlier module 122 first uses the expected model calculation module 504 to calculate the effect on the expected model induced by making a small change to the observed distribution, e.g., by removing a single record from the sample (block 604). A modified expectation model is calculated, based on the changed observed distribution (block 606). The changed observed distribution is then compared to the changed expected model (block 608), e.g. by using the scoring function module 506.

The change that affects the comparison score the most (e.g., decreases the deviation by the largest amount when compared to others) is chosen by the outlier module 122 (block 610).

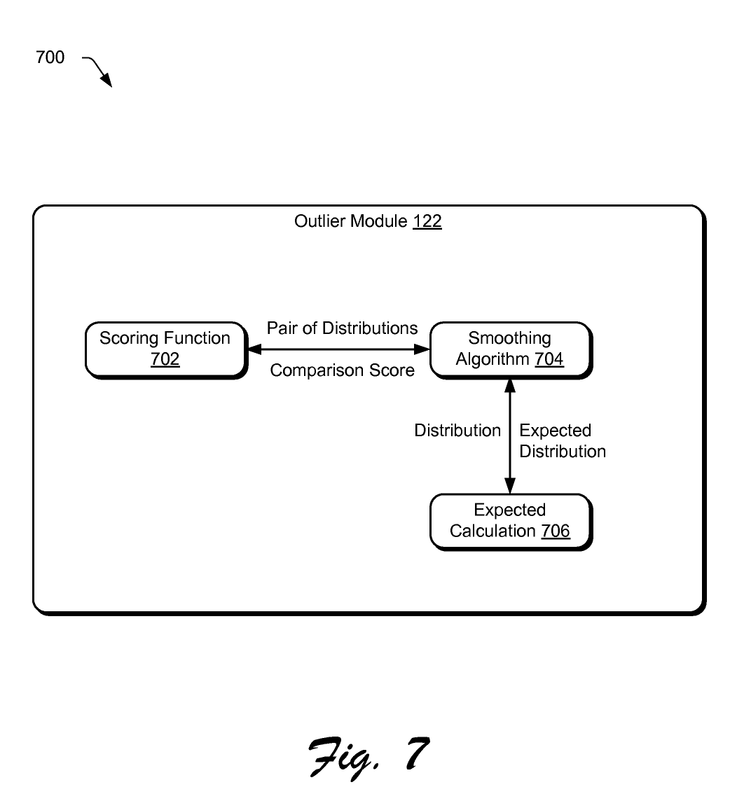

This procedure is also represented in the example system 700 of FIG. 7, which illustrates communication between a scoring function 702, a smoothing algorithm 704 and an expected calculation 706 of the outlier module 122 of FIGS. 1 and 5.

The proposed change is then assessed in order to evaluate its significance (block 612). If the change is not significant enough, the module outputs the modified distribution (block 616); this ensures that the changes are warranted such that the distribution is not changed when the distribution does not have outliers. Otherwise, the overall amount of change to the observed distribution is checked. If it is below a preset threshold (decision block 614), the procedure 600 of FIG. 6 iteratively repeats itself. Otherwise, the overall change has exceeded its threshold, e.g. exceeds a pre-specified fraction of the total population, and the distribution is declared unstable (block 618). For example, the outlier removal techniques may be used to iteratively change the distribution, while using the main guidelines:

(1). Steepest descent: make the change that reduces the distance between the distributions the most when compared with other changes.

(2). Contribution of the change: make changes that affect the result above a threshold amount.

(3). Moderate changes: do not allow the total change to the observed distribution (accumulation of each of the changes performed by the iterative algorithm) to extend beyond a threshold amount, which may be different than the threshold amount described in guideline (2).

Implementation Example

The following is an example of various functions and conditions that may be used by the outlier removal techniques described herein:

Distributions—Discrete (Binned) Distributions

This example addresses input distributions that are discrete. The distributions are k dimensional, but each of the parameters has a set of discrete values it may accept.

Expected Calculation—Independence Model

The expected calculation is made by taking the k−1 dimensional marginal distributions of a given k dimensional distribution, and calculating the highest entropy k dimensional distribution that shares the same k−1 marginal distributions. This can be achieved by means of an algorithm such as iterative scaling.

The score is a chi square score. For example, given two distributions (observed and expected) sharing the same defining parameters, the score may be obtained by taking the chi square score.

“Small” Changes.

The small changes that are permitted in an implementation are a reduction of a single record from the sampled distribution. In an implementation, since the distribution is discrete, this equates to a reduction of one from one of the cells of the multivariate distribution. This means that the number of possible changes is the number of cells rather than the number of cases. Out of these small changes, the one that reduces the chi square score the most is chosen; recall that the chi square score is bigger when the distribution deviates more.

Significant Score Change Verification

In an implementation, the change to the chi square score is verified to be “big enough” (above a threshold) either relative or absolute to the previous score or both. The following lists two example boundaries that may be used to define this threshold:

(1). The difference of the two chi square scores is to exceed a predefined threshold; and

(2). The ratio between the difference and the original score also exceeds a threshold.

“Too Many Changes” Verification

A change is considered negligible if the amount of changes is small with respect to the total number of samples, or absolutely. This condition is checked by the outlier module 122.

Segment Extraction

An input typically provided to a data mining application may be described as a panel where the rows are records or cases and the columns are variables or attributes or parameters describing these cases. This panel is often taken to be a sample of an underlying multivariate distribution over the variables. Given such input, a goal of a data mining application includes identification of intra-dependent pairs, or larger subsets, of the variables.

While informative of the nature of the data, the information that a subset of variables is intra-dependant is often not actionable. Conversely, segmentation information (e.g., the identification of interesting subsets of the cases) is highly useful for the user. A segment, in the context of the previously described embodiment for the segment extraction module, is rule-based, namely a subset of cases that is defined by a set of rules over one or more variables, and that exhibits some distinct behavior from another segment or the general population. This simple definition is readily understood even without a statistical or data-mining background, and thus is useful to business and marketing professionals lacking such expertise. Being a subset of the cases, a segment naturally provides a target audience for policies that are defined by such professionals on the basis of its definition and distinct behavior.

This section describes one or more techniques that address the problem of providing actionable data-mining results. The techniques described herein provide extraction of a list of segments that captures the essence of the dependencies of a set of input variables from a sample of a respective multivariate distribution.

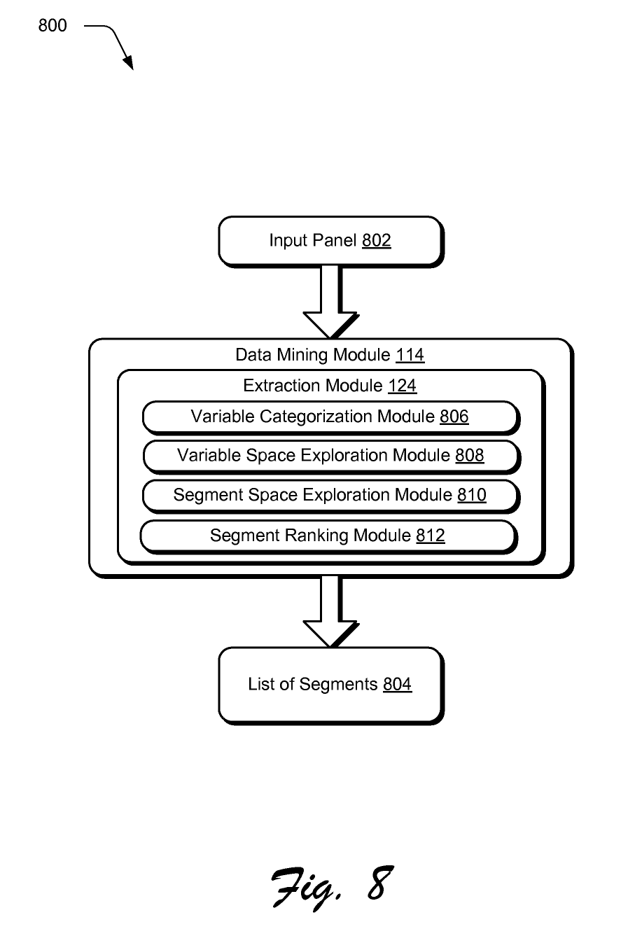

FIG. 8 depicts an implementation example 800 showing the extraction module 124 of FIG. 1 in greater detail. An input panel 802 is illustrated as an input for the data mining module 114, which is a panel of cases by variable. Each variable may be continuous or discrete, ordered or nominal. Let T⁽ⁱ⁾ denote the input panel. A list of segments 804 is illustrated as the output of the data mining module 114, and more particularly the extraction module 124. Each of the segments in the list of segment 804 may be defined by “simple” rules over a relatively small subset of variables, and exhibit distinct behavior as previously described. The definition of what are interesting behaviors may be given by a segment ranking function. The extraction module 124 is illustrated as including four modules, which are further described in the following sections.

Variable Categorization Module 806

The input to the variable categorization module 806 is a column of T⁽ⁱ⁾, e.g., the values of a single variable over each of the cases. The output is a categorization of that variable, e.g., a mapping from the values of the variable to a set of discrete values (e.g., categories), plus a reflexive partial order relation over the categories. For purposes of the discussion, let T^{(c)} be the input panel, after categorization. The partial order constrains the rules that may be defined over the variable as described hereafter. Various functionalities of the variable categorization module are described in paragraph [0051].

Segment Ranking Module 808

The input to the segment ranking module 808 is T^{(c)}, plus rules defining a segment. The output is a rank for the segment.

Segment Space Exploration Module 810

The segment space exploration module 810 is a representation of functionality to explore the space of segments over a fixed subset of variables. The input to this module is small subset D of the input variables, and the corresponding columns of T^{(c)}. The output is a list of candidate segments defined by simple rules over D. One implementation for this module outputs each of the segments within the space of segments that are definable over the small subset D of the input variables. Other implementations perform some exploration of that space, which may be guided by the segment ranking module 808.

Variable Space Exploration Module 812

The variable space exploration module 812 may receive as an input T^{(c)}. The output is a list of subsets of variables that are candidates for defining segments. One implementation for the variable space exploration module 812 outputs each of the subsets of variables up to a given cardinality. Other implementations may explore the space subsets of variables by observing the columns of T^{(c)}, by sampling calls to the segment space exploration module 812, and so on.

A variety of other modules may be employed by the data mining module 114. For example, a representative segment selection module may receive as an input a list of candidate segments defined by simple rules over D, which is a subset of the variables. The output is a list of non-redundant, highest ranking segments out of the input list, further discussion of which may be found in a respective section below titled “Representative segments selection module”. A control module may also be included to coordinate the various modules. A variety of other examples are also contemplated.

Single Variable Rules

The rules that may be declared over a single variable may be constrained by a reflexive partial order that is defined over categories of the variable categorization module 806. For example, let X be the variable, [n] the set of categories defined for the variable, and ≦ the reflexive partial order defined over them. Consequently, rules of the form a≦X, X≦b, and a≦x≦b are allowed, where a, bε[n]. For example, if the variable is unordered, then the reflexive partial order will degenerate, e.g., each category relates to itself alone, and each of the rules would be of the form X=a. If, on the other hand, the order is complete, then any range of values is possible.

Segment Defining Rules

Segments may be defined by a Boolean formula over single variable rules. The formula may include a variety of possibly nested combinations of disjunctions or conjunctions of single variable rules. Any specific implementation of the segment space exploration module 812 may be used to define which formulas are used.

Implementation Example

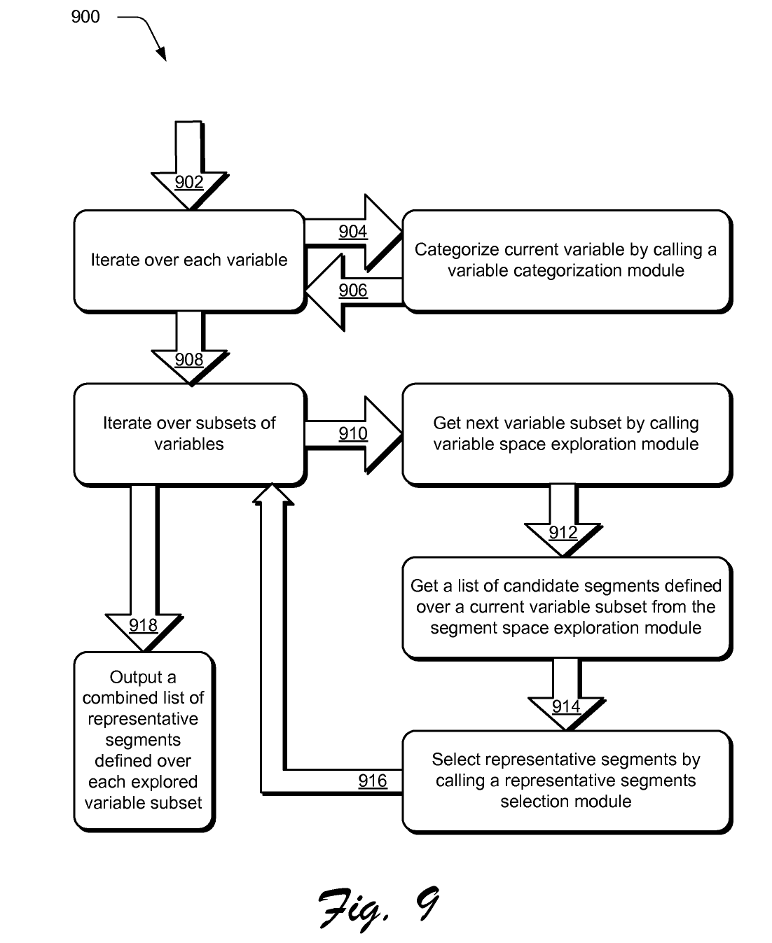

FIG. 9 depicts a procedure 900 in an example implementation in which segments are extracted from a multivariate distribution. Aspects of this procedure may be implemented in hardware, firmware, or software, or a combination thereof. The procedure is shown as a set of blocks and arrows that specify operations performed by one or more devices and are not necessarily limited to the orders shown for performing the operations by the respective arrows. In portions of the following discussion, reference will be made to the environment 100 of FIG. 1 and the system 800 of FIG. 8.

At arrow 902, an input T⁽ⁱ⁾, is received, which is a panel of cases by variables. At arrow 904, an uncategorized column of T⁽ⁱ⁾ is passed to be categorized by calling the variable categorization module 806. In response at arrow 906, a categorization is output of the column, plus a reflexive partial order over the categories.

At arrow 908, T^{(c)}—a panel of cases by categorized variables and ≦(a reflexive partial order over the categories of each variable) is passed to iterate over subsets of variable.

At arrow 910, the full set of variables is passed such that a next variable subset is provided by calling the variable space exploration module 812.

At arrow 912, D (a subset of variables) is passed such that a list of candidate segments defined over a current variable subset may be provided from the segment space exploration module 810.

At arrow 914, C_{D}—a list of candidate segments defined by rules over D is passed such that a representative segment may be selected by calling the representative segments selection module.

At arrow 916, R_{D}—a representative non-redundant list of high ranking segments defined by rules over D is passed and the iteration over subsets of variables continues. This list of segments captures the essence of the intra-dependencies of the variables of D, and inter-dependencies between the variables of D and variables outside of D.

At arrow 918, an output is provided which includes a combined list of all representative segments defined over each of the explored variable subsets, thereby capturing the essence of the dependencies of the variables in the panel.

Representative Segments Selection Module

This module receives as input a list C_{D} of candidate segments defined by rules over a subset of variables D, and outputs a representative, non-redundant list of high-ranking segments out of this list. The module may utilize a ranking function defined by the segment ranking module 808, which is denoted here by r.

In an implementation where each segment is defined by a Boolean combination of rules of the form a≦x≦b, the intersection of two segments is a segment that may be defined by the same language of rules, and may thus be ranked by r. Therefore, the partial order may be defined over C_{D}, which is defined by a>b if and only if the following two conditions hold:

r(a)>r(b); and (1.)

r(a∩b)>γr(b) (2).

where γ is a predefined positive parameter. The dominating set of the transitive closure of > is the representative list of segments outputted by the module.

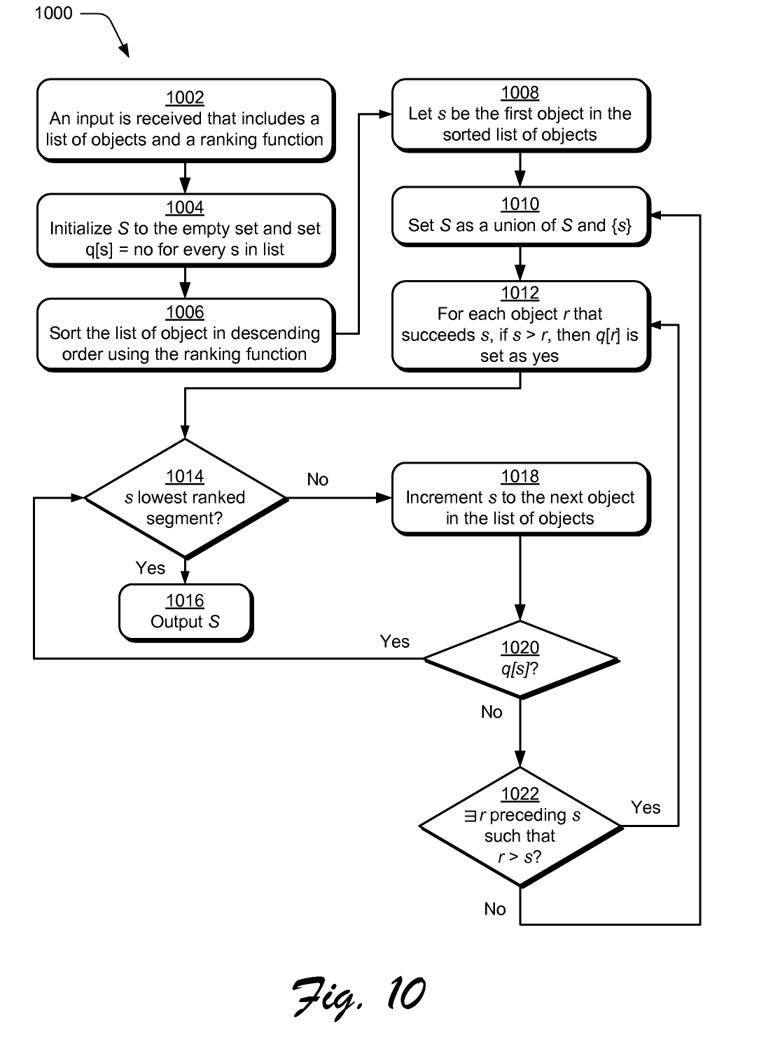

FIG. 10 depicts one example of a procedure 1000 that may be used to calculate this list. At block 1002, an input is received that includes a list of objects C_{D}, and a ranking function r: C_{D}

[symbol]

At block 1004, the set S, which will eventually hold the dominating set, is initialized to the empty set. Additionally, q[s] which will mark objects known to be dominated, is set to “no” for all sεC_{D} to.

At block 1006, the list of objects is sorted in descending order by the ranking function.

At block 1008, let s be the first object in the sorted list of objects.

At block 1010, S is set as a union of S and {s}.

At block 1012, for each object r that succeeds s, if s>r, then q[r] is set as yes.

At decision block 1014, a determination is made as to whether s is the lowest ranked segment. If so (“yes” from decision block 1014), S is output (block 1016). If not (“no” from decision block 1014), s is incremented to a next object in the list of objects (block 1018).

A determination is then made as to whether q[s] is true (“yes”) (decision block 1020). If so (“yes” from decision block 1020), the procedure returns to decision block 1014 to determine whether s is the lowest ranked segment.

If not (“no” from decision block 1020), a determination is then made as to whether ∃r preceding s such that r>s (decision block 1022). If not (“no” from decision block 1022), the procedure returns to block 1010 such that S is set as a union of S and {s}. If so (“yes” from decision block 1022), the procedure returns to block 1012 such that for each object r that succeeds s, if s>r, then q[r] is set as yes. The procedure 1000 may then continue until S is output at block 1016.

Segment Ranking

The ranking module 126 is representative of functionality of the data mining module 114 to rank segments, e.g., segments extracted by the extraction module 124. Given a data sample consisting of records drawn from a population and one or more attributes for each record, a variety of traditional techniques may be employed to group together similar records in order to organize or classify the data, thereby making it simpler to grasp and hence more actionable. Popular examples are k-means clustering, principal component analysis, decision trees, and so on.

These traditional techniques are often compared against each other on common data sets to identify which technique works best in a particular circumstance. This comparison often involves subjective criteria supplied by the data analyst to the results post factum, such as criteria that are not implemented in the objective functions being optimized by the various methods. As a consequence, the objective function may not accurately reflect the actual business agenda, resulting in a less than optimal solution. Furthermore, the data analyst may have little leeway in leveraging the external knowledge of the analyst with these traditional techniques, such as knowledge regarding the nature of the data or the business goals. Finally, once these traditional techniques output respective results, an organic feedback mechanism is not provided to refine the data mining process so as to produce better results.

Traditional techniques may allow the analyst a choice among several objective functions, e.g., to optimize behavioral targeting segments for reach or for accuracy, and a choice from a parameterized family of solutions (precision/recall tradeoff). At most, the analyst may set priorities on class probabilities and misclassification costs for classification trees, but this optimizes the tree as a “black-box” classifier without affecting segment-level metrics. As for unsupervised learning, user feedback is even more basic, e.g., a number of clusters for k-means.

Techniques are described in this section that may incorporate multiple context-specific a-priori business considerations into an optimization model, over and above an objective statistical framework. For example, these techniques may incorporate use of a customizable segment rank, which may model both subjective business considerations and statistical significance. In another example, these techniques may incorporate user feedback organically into the modeling process to refine the objective function, which may cycle back and forth until a desirable result is reached.

In an implementation, these techniques may aggregate individual data records into a multiplicity of partial segment scores such as reach, lift, Key Performance Indicators (henceforth KPI's), attribute distribution and deviation from user-configurable expectation models calculated from the data. The scores may then be combined in a user-configurable manner to a subjective rank which serves as a proxy to each segment's interest or value. For example, the segments may be optimized according to this rank (either individually or in context of the multiplicity of segments) and presented to the user in descending order. A user-specific dynamic knowledge base may also be employed to seed the initial ranking before segmentation begins, and then interface with the user to register feedback and re-rank existing segments or update the segment list.

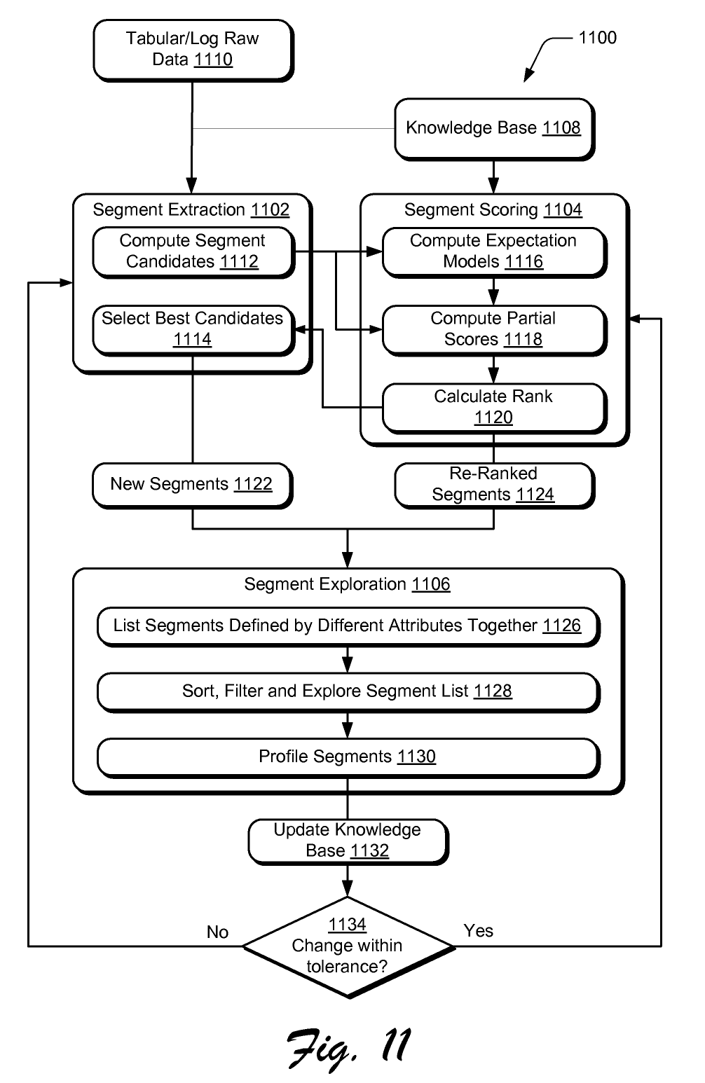

FIG. 11 depicts a procedure 1100 in an example implementation of segment discovery and ranking that may involve user input is shown. Aspects of this procedure may be implemented in hardware, firmware, or software, or a combination thereof. The procedure is shown as a set of blocks that specify operations performed by one or more devices and are not necessarily limited to the orders shown for performing the operations by the respective blocks. In portions of the following discussion, reference will be made to the environment 100 of FIG. 1.

The procedure is shown as involving several subsystems that may be implemented as one or more modules, examples of which include segment extraction 1102, segment scoring 1104, segment exploration 1106 and a knowledge base 1108.

Segment extraction 1102 is illustrated as receiving an input of tabular/log raw data 1110. Segment extraction 1102 is also illustrated as receiving an initial user-specified or default configuration of the knowledge base 1108. Segment extraction 1102 may or may not correspond to the extraction module 124 of FIGS. 1 and 8.

Segment extraction 1102 may also include a variety of sub-modules, such as a candidate generator and a segment selector. The candidate generator may be used to compute segment candidates 1112, e.g., to enumerate over potential segments prescribed by the knowledge base 1108. The segment selector may be used to select the best candidates 1114, e.g., to choose representative segments with respect to the subspaces defined by different sets of attributes.

For example, segment extraction 1102 (and more particular the candidate generator) may provide candidates to segment scoring 1104. Segment scoring 1104 may then compute expectation models 1116, compute partial scores 1118, calculate ranking 1120, and then provide this output back to segment extraction 1102. In this way, the segment selector 114 may then use an output of segment scoring 1104 to select the best candidates 1114. An output of the segment extraction 1102 is a list of ranked segments, which is illustrated as new segments 1122 in the procedure 1100 of FIG. 11.

Segment scoring 1104 may receive as an input a segment or a potential segment; a user-specified list of partial scores, possibly including size, lift, KPI's and deviation from user-specified expectation models, said scores either to be computed by Compute Partial Scores 1118, or already computed, in which case the input includes their pre-computed values; and a user-specified technique to compute segment rank from partial scores. Segment scoring 1104 provides as an output ranked segments for Select Best Candidates 1114 or re-ranked segments 1124 and cached partial scores which may serve as sufficient statistics for future manipulation of the data. These scores may include partial calculations which do not contribute directly to the segment rank but allow quick re-calculation of partial scores once the knowledge base is modified.

Segment scoring 1104 may be formed from a variety of sub-modules, such as an expectation generator to compute expectation models 1116, a partial score module to compute partial scores 1118 and a rank calculator module to calculate rank 1120.

The expectation generator may be used to compute expected attribute distributions over a segment population according to a user-specified model. Examples include distribution over a total population from which the segment is drawn, distribution in a reference population, an independence model, a maximum entropy model for n-tuple distribution given (n−1)-tuple marginals computed by iterative scaling, and so on.

The partial score module may be used to compute partial scores, such as user-specified scores including deviation of observed attribute distributions from expectation models, an example of which is shown as follows:

$$lift = \frac{observed}{expected} - 1$$

The rank calculator module may be used to calculate rank 1120 in a variety of ways. For example, the rank calculator module may calculate rank 1120 from partial scores according to the following expression:

rank=lift·min(size^{α},maxtradeoff)

where α is a user-specified tradeoff between lift and size (e.g., between 0.05 and 0.2) and maxtradeoff is the user-specified contribution of size (e.g., between 0.01 and 0.1), over and above lift. In this case, of two segments with equal or nearly equal lift, the larger segment would be ranked higher, much as a human analyst would decide.

The rank calculator module may also calculate rank 1120 according to the following expression:

$$rank = {[ \frac{{\sum }_{i} {( {w}_{i} \cdot {s}_{i} )}^{\frac{1}{α}}}{{\sum }_{i} {( {w}_{i} )}^{\frac{1}{α}}} ]}^{α}$$

where wᵢ is the weight the user attributes to behavioral attribute i, sᵢ is the partial score and 0≦α≦1 is the user-specified attribute mixing parameter: from α=0 (limit value) for weighted maximum to α=1 for simple weighted average, typically 0.1 to 0.3.

The rank calculator module may further calculate rank 1120 according to the following expression:

$$rank = \frac{{\sum }_{i} {w}_{σ ( i )} {s}_{σ ( i )} {α}^{i}}{{w}_{τ ( i )} {α}^{i}}$$

where σ permutes the attribute indices such that w_{σ(i)}s_{σ(i)} is descending, τ permutes the attribute indices s.t. w_{τ(i)} is descending, and 0≦α≦1 is the user-specified rate of exponential decay from each attribute to its successor.

Segment exploration 1106 may receive, as an input, new segments 1122 from segment extraction 1102 and/or re-ranked segments 1124 from segment scoring 1104. For example, segment exploration 1106 may receive a list of ranked segments that may be defined by different sets of attributes.

In an implementation, segment exploration 1106 may output a user interface to provide for segment list manipulation and segment viewing. The user interface may also be used to provide a display of sorted, filtered or otherwise manipulated segment lists and provide various layers of drill down and segment profiling.

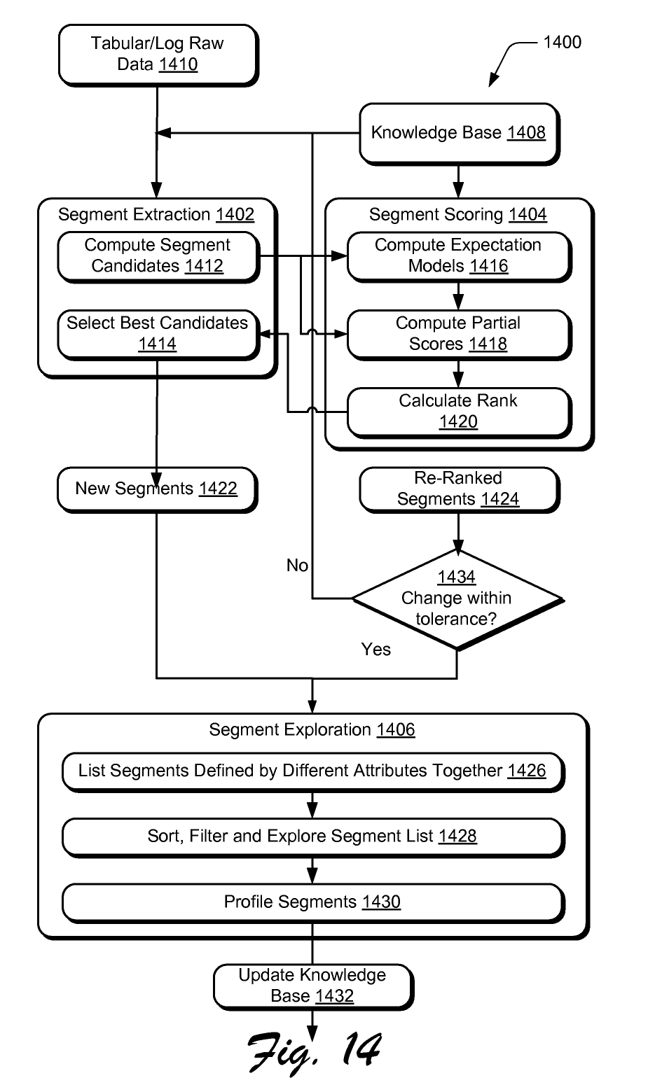

Segment exploration 1106 is illustrated as providing a variety of functionality, such as to list segments defined by different attributes together 1126, sort, filter and explore a segment list 1128 and profile segments 1130. This functionality may then be used to update the knowledge base 1132. Another functionality may call Segment Scoring 1104 to re-rank existing segments once the knowledge base 1108 has been modified. In yet another functionality, a determination is made if the changes to the knowledge base are within tolerance (decision block 1134). This determination could be made at the level of the knowledge base 1108, or by re-ranking some or all of the existing segments with Segment Scoring 1104 and comparing the new segment ranks to the old (FIG. 14 decision block 1434). If the changes to the knowledge base 1108 are deemed within tolerance, Segment Scoring 1104 is called to re-rank all existing segments, producing re-ranked segments 1124. If the changes are deemed not within tolerance, Segment Extraction is called to produce New Segments 1122.

The previous discussion of the procedure 1100 of FIG. 11 described a variety of functionality that may be incorporated by the ranking module 126. A variety of other functionality may also be employed without departing from the spirit and scope thereof.

For example, the ranking module 126 may incorporate a learning module that may receive, as an input, user dependent changes to the knowledge base 1108 that may affect computation of partial segment scores and the way the scores are combined into segment rank. In this way, the learning module may improve segmentation results (segment selection and rank function) to fit a variety of business agendas.

The learning module may incorporate a variety of techniques to provide this functionality, alone or in combination. For instance, the learning module may utilize analytic learning such that the user specifies rules or parameter values in an explicit manner. In another instance, the learning module may utilize empirical learning to infer rules or desirable parameter values from user feedback. For example, the user may filter out segments defined by parameter X and the module may then suggest lowering the rank of segments defined by parameter Y, because X and Y are similar or belong to the same parameter class. In a further instance, the module may utilize machine learning to optimize the knowledge base 1108 to best match the rank function to the user manipulated segment list in a “black-box” (e.g., automatic) machine learning approach. A variety of other examples are also contemplated.

The ranking module 126 may also incorporate re-ranking functionality that receives as input a segment list, cached partial scores and the knowledge base 1108. The output from this functionality includes ranks for each segment in the list, which may be based on cached partial scores and/or newly computed scores; cached values of new partial scores or sufficient statistics for computing partial scores, and so on. A variety of other examples are also contemplated.

Behavioral Profiling

The behavior module 128 is representative of functionality of the data mining module 114 to analyze segments using behavioral profiling. Given a panel where the rows are cases and the columns are attributes describing these cases, a segment may be considered a subset of the rows. Segments may be used in many business and marketing setups. In some setups, segments are manually defined, while in others the segments may be produced automatically. Regardless of the definition of the segment, interesting segments may demonstrate interesting behavior over some of the attributes. Understanding these interesting behaviors often helps to define business and marketing policies regarding the segment. However, the identification, quantification, and presentation of interesting behavioral attributes for a given segment are not simple problems.

A traditional technique of examining the behavior of a segment over a given attribute is to observe the distribution of the attribute over the segment cases. Another traditional technique involves comparison of some statistical measures of the attribute, such as its mean, within the segment and in the general population. It is also possible to combine the two techniques and compare the distribution of the attribute over the segment with its distribution over the general population. However, most distribution comparison methods are inadequate for this task since these methods are generally considered difficult to understand and review by business and marketing professionals.

Techniques are described that may define an observed and reference distribution for each candidate behavioral attribute with respect to a segment, and may compare these two distributions in a manner that is comprehensible and verifiable by business and marketing professionals. Accordingly, these techniques may be used to address the problem of identifying, quantifying and presenting interesting behavioral attributes for a given segment.

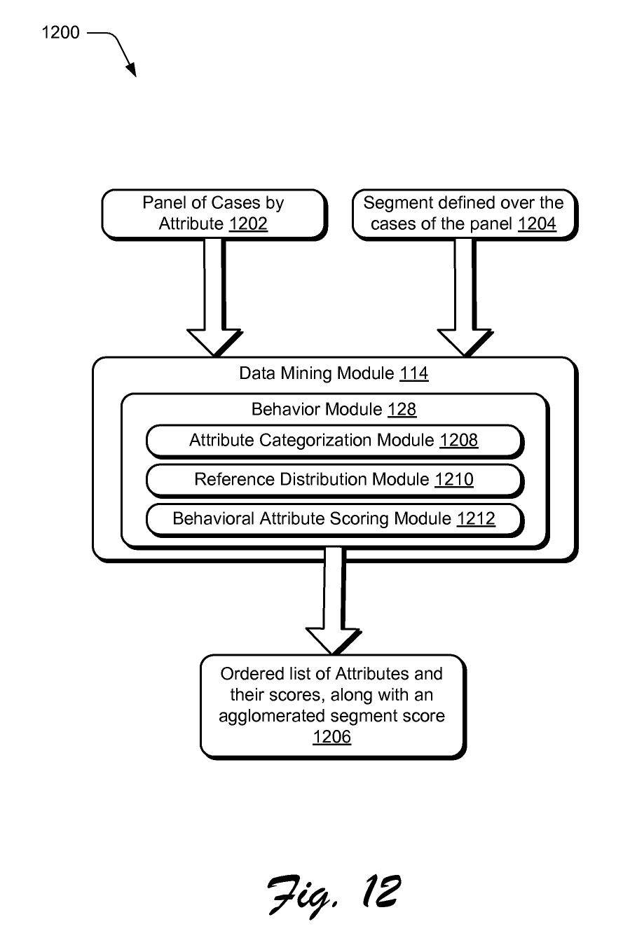

FIG. 12 depicts a system 1200 in an example implementation showing the behavior module 128 of FIG. 1 in greater detail. An input for the behavior module 128 is illustrated as a panel of cases by attributes 1202. Each attribute may be continuous or discrete, ordered or nominal. For purposes of the following discussion, let T⁽ⁱ⁾ denote the input panel such that the discussion shall interchangeably refer to the columns of T⁽ⁱ⁾ as attributes, and vice versa.

Another input is illustrated as a segment defined over the cases of the panel 1204. The segment may be given as a list of case ids, or as a rule defining whether a given case belongs to the segment. The output is an ordered list of attributes over which the segment displays interesting behaviors, which may also be referred to as “behavioral attributes”, along with their individual scores and an overall segment rank, e.g. as calculated in paragraph [00128] (output block 1206). The behavior module 128 is further illustrated as including the following modules.

Attribute Categorization Module 1208

The attribute categorization module 1208 may accept as an input a column of T⁽ⁱ⁾, e.g., values of a single attribute over each case. The output may be configured as a categorization of that attribute, e.g., a mapping from the values of the attribute to a set of discrete values (e.g., categories). For purposes of the discussion, let T^{(c)} be an input panel, after categorization. In some instances, the input column is already categorized and therefore this module may act to return the input as an output. Various functionalities of the variable categorization module are described in paragraph [0051].

Reference Distribution Module 1210

The reference distribution module 1210 is representative of functionality of the behavior module 128 to provide a definition of a reference distribution 1210. The reference distribution module 1210 may accept as an input a segment definition rule or a list of case ids, T^{(c)}, and a reference b to a column of T^{(c)}. The output may be configured as an absolute distribution over the categories of b. This module may be configured in a variety of ways.

For example, the reference distribution module 1210 may be configured to provide a total population reference distribution. In this embodiment, the reference distribution is the distribution of the candidate behavioral attribute b over all the rows of T^{(c)}.

In another example, the reference distribution module 1210 may be configured to provide an expected reference distribution. For example, this example may be employed when a rule defining the segment is given as a Boolean function over a relatively small number of simple rules, each defined over a single column of T^{(c)}. These columns may be referred to as “segment defining attributes, d.”

For example, let the distribution defining attributes, \tilde{d}=d∪{b}, be the set of attributes composed of the segment defining attributes, d, plus the candidate behavioral attribute, b. Let k be the cardinality of \tilde{d}. Let D be a Cartesian product of the categories of \tilde{d} and let the observed distribution O be a multivariate distribution of the cases in the segment over D.

The expected distribution E may be defined to be a maximal entropy multivariate distribution over D that agrees with O on each k−1 dimension marginal. E may be calculated using iterative scaling.

By applying the rules defining the segment on E, the expected distribution may be obtained over the categories of the candidate behavioral attribute in the segment. This is the reference distribution returned by this embodiment of the module.

Behavioral Attribute Scoring Module 1212

The behavior attribute scoring module 1212 may receive as an input two distributions over a same set of categories, e.g., the first is the distribution of the cases of the segment over the categories of a candidate behavioral attribute, the second is a reference distribution over the same candidate behavioral attribute returned by the reference distribution module 1210. The output is a score indicating a relative degree (e.g., how “interesting”) of the behavior of the segment is over the candidate behavioral parameter.

The behavioral attribute scoring module 1212 may be configured to function in a variety of ways. For example, the input of the module may be composed of two absolute distributions. The first is a distribution over the categories of the candidate behavioral attribute of the cases in the segment. The second is a reference distribution over the same set of categories.

The behavioral attribute scoring module 1212, for instance, may employ an agglomerated lift rank technique in which a score is calculated separately for each category of the candidate behavioral attribute. The scores may then be agglomerated to form a single score for the segment.

For example, let \vec{o}=(oᵢ) and \vec{e}=(eᵢ) be the first and second input distributions, respectively, where i runs over the categories of the candidate behavioral attribute. Let l=(lᵢ) be the lift vector, given by lᵢ=oᵢ/eᵢ−1.

The score of category i is a combination of its size and its lift given by xᵢ=s(oᵢ, eᵢ)=σ(oᵢ)τ(lᵢ), where σ and τ and utility functions converting size to size score and lift to lift score.

The overall score of the candidate behavioral attribute may be represented as follows:

$$s = {( {\sum }_{i} \frac{{( {w}_{i} {x}_{i} )}^{α}}{{\sum }_{i} {w}_{i}^{α}} )}^{1 / α}$$

where α is a parameter accepting values between 0 and 1, and wᵢ is the non-negative weight ascribed to attribute i.

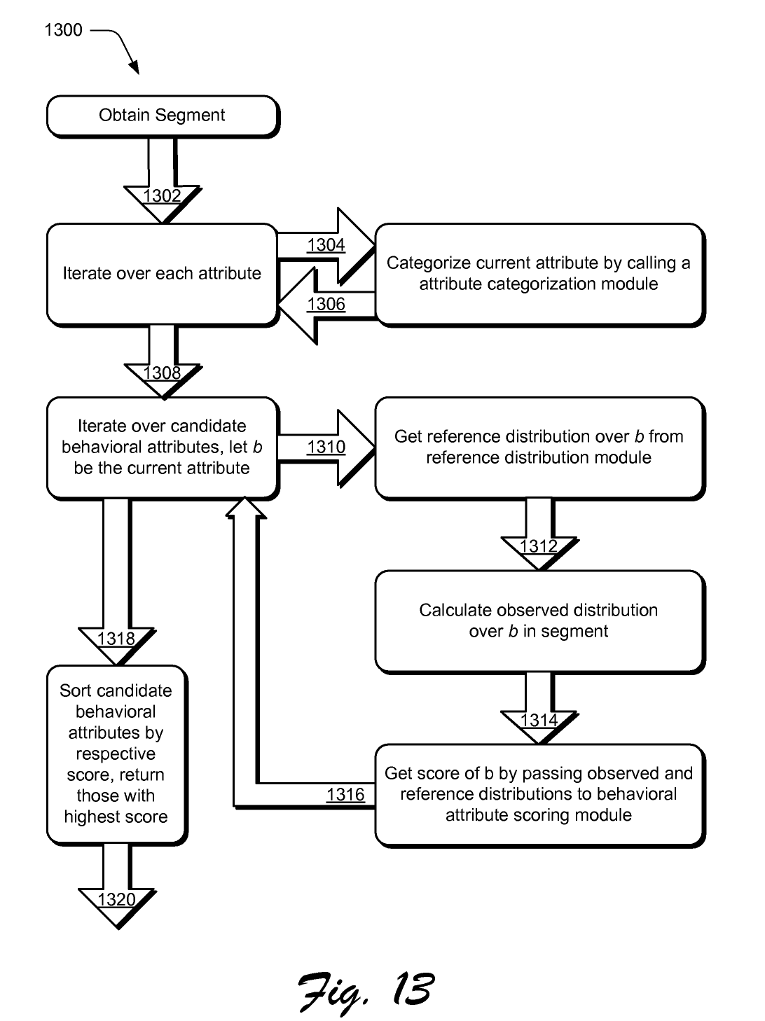

FIG. 13 depicts a procedure 1300 in an example implementation in which a list of behavior attributes is output that show interesting behavior. Aspects of this procedure may be implemented in hardware, firmware, or software, or a combination thereof. The procedure is shown as a set of blocks and arrows that specify operations performed by one or more devices and are not necessarily limited to the orders shown for performing the operations by the respective arrows. In portions of the following discussion, reference will be made to the environment 100 of FIG. 1 and the system 1200 of FIG. 12.

At arrow 1302, an input is received that is then iterated over each attribute. The input includes T⁽ⁱ⁾ (a panel of cases by attributes), s (a segment) given as a rule identifying which rows of T⁽ⁱ⁾ belong to the segment. The rule may be configured in a variety of ways, such as a list of row identifiers.

At arrow 1304, an uncategorized column of T⁽ⁱ⁾ is passed to be categorized by calling the attribute categorization module 1208. At arrow 1306, a categorization of the column is output.

At arrow 1308, T^{(c)} (a panel of cases having categorized attributes) is passed to iterate over candidate behavioral attributes. Let b be the current attribute.

At arrow 1310, T^{(c)}, s and b (an identifier of a candidate behavioral attribute) is passed to get a reference distribution over b from the reference distribution module 1210.

At arrow 1312, T^{(c)}, s, b, and \vec{e} (a reference absolute distribution over the categories of b|) are passed to calculate an observed distribution over b in the segment.

At arrow 1314, \vec{e} and \vec{o} (the distribution of b over the rows of T^{(c)} that belong to s) are passed to get a score of b by passing observed and reference distribution to the behavioral attribute scoring module 1212. As a result, arrow 1316 passes q(b), which is a score indicating how interesting is the behavior of s is over b. An input is received at arrow 1318 which includes q(b) for each of the candidate behavioral attributes b. Candidate behavioral attributes are then sorted by respective score, and those with the highest score are returned.

The output at arrow 1320 is a list of behavioral attributes showing interesting behavior over s, sorted by their score. For each behavioral attribute, the relevant \vec{e} and \vec{o} may also be output together with information describing the score assigned to the behavioral attribute, alongside the overall segment score.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method performed by one or more devices comprising:
obtaining client data that describes interaction of a plurality of clients with an online provider;
finding segments that demonstrate distinct behavior in one or more attributes over the plurality of clients described in the client data;
applying a ranking function to the segments, the ranking function containing pre-coded settings that specify a business agenda; and
outputting a list of the segments ranked according to the application of the ranking function.

2. A method as described in claim 1, wherein the client data describes one or more Internet services with which a respective said client has interacted.

3. A method as described in claim 1, wherein the client data describes one or more characteristics of a respective said client.

4. A method as described in claim 1, wherein the outputting is performed via a user interface of the one or more devices.

5. A method as described in claim 1, wherein the pre-coded settings are specified by an advertiser to target one or more said clients that correspond to respective said segments.

6. A method as described in claim 5, wherein the advertiser includes one or more online advertisements to be output by the online provider.

7. A method as described in claim 5, wherein the advertiser includes one or more online advertisements to be output by a third party.

8. A method as described in claim 1, further comprising reapplying the ranking function to the segments using one or more setting received as an input via the user interface after the outputting.

9. A method as described in claim 1, wherein the client data includes demographic data provided by a respective said client through a registration process, a browsing history or a search query history.

10. A method as described in claim 1, wherein the client data includes a newsletter subscription, a blog or data describing interaction with a social network.

11. One or more computer-readable media comprising instructions that are executable on a device to output a user interface describing a list of segments ranked according to a ranking function, the segments demonstrating distinct behavior in one or more attributes over a plurality of clients described in client data and the ranking function containing settings that are enterable via the user interface to specify a business agenda.

12. One or more computer readable media as described in claim 11, wherein the client data describes one or more Internet services with which a respective said client has interacted.

13. One or more computer readable media as described in claim 11, wherein the client data describes one or more characteristics of a respective said client.

14. One or more computer readable media as described in claim 11, wherein the settings are specified by an advertiser to target one or more said clients that correspond to respective said segments.

15. One or more computer readable media as described in claim 11, wherein:
the settings are specified by an advertiser to target one or more said clients that correspond to respective said segments; and
the advertiser includes one or more online advertisements to be output by an online provider.

16. One or more computer readable media as described in claim 11, wherein the user interface is accessible by an online advertiser to specify particular advertisements that are to be output by particular said clients that correspond to respective said segments.

17. One or more computer readable media as described in claim 11, wherein the clients are customers of a telecom company.

18. One or more computer readable media as described in claim 11, wherein the client data includes demographic data provided by a respective said client through a registration process, a browsing history, a search query history, a newsletter subscription, a blog, data describing interaction with a social network, or a third party data provider.

19. A system comprising one or more modules to output a user interface to target advertisements to particular ones of a plurality of clients that interact with an Internet search provider, the particular said clients identified in the user interface using segments ranked according to a ranking function, the segments demonstrating distinct behavior in one or more attributes over the plurality of clients described in client data.

20. A system as described in claim 19, wherein the one or more modules include functionality to perform the Internet search.
